(19) United States
(12) Patent Application Publication
(10) Pub. No.: US 2009/0277759 A1
(43) Pub. Date: Nov. 12, 2009

(54) Toggle switch lock

(76) Inventor: Glenn Eldon Squires, North Fort Myers, FL (US)

Correspondence Address: GLENN ELDON SQUIRES, 4431 SAINT CLAIR AVENUE, NORTH FORT MYERS, FL, 33903, US

(21) Appl. No.: 12/151,693

(22) Filed: May 8, 2008

(51) Int. Cl. H01H 9/28

(52) U.S. Cl. 200/43.19

(57) ABSTRACT

A toggle switch lock includes a main body portion, a pair of switch lock mounting holes, and a switch position aperture. The main body portion is adapted to attach to a toggle switch faceplate having a pair of faceplate mounting holes, such that a first portion of the toggle switch that represents an off or on state abuts the main body portion so as to lock the switch in the state, a second portion of the toggle switch that represents the other state extends through the switch position aperture, and the switch lock mounting holes are aligned with the faceplate mounting holes. The switch lock can be attached in two different orientations relative to the toggle switch. The switch lock can also be embodied in a switch locking faceplate.

### FIELD OF THE INVENTION

The present invention relates to switch locks, and more specifically, to toggle switch locks.

### BACKGROUND OF THE INVENTION

Toggle switches are used to control on and off (or closed and open) states for electrical devices. Toggle switches general do not provide means for locking in one state or the other.

A prior solution was to provide a locking box that covers such a switch thereby preventing access to the switch. Accordingly, a key or would be required to unlock the box to access the switch. Another prior solution was to provide a lock for a standard-type toggle switch (cf, decor or decora-type toggle switch), in which a substantially rectangular-shaped element would abut the switch's actuator when in one position so as to prevent the actuator from moving towards the element. The element would attach to a face plate via a single mounting hole that would align with one of the two mounting holes of the faceplate.

### BRIEF SUMMARY OF THE INVENTION

It is, therefore, an object of the present invention to provide a toggle switch lock.

In an exemplary embodiment, the present invention can be embodied in a toggle switch lock for locking a toggle switch in one of an off position and an on position, comprising a main body portion formed of a rigid material, a pair of switch lock mounting holes defined by the material, and a switch position aperture defined by the material. The main body is adapted to attach to a toggle switch faceplate having a pair of faceplate mounting holes, such that a first portion of the toggle switch that represents the one of an off position and an on position abuts said main body portion so as to lock the switch in the one of an on position and an off position, a second portion of the toggle switch that represents the other of an off position and an on position extends through said switch position aperture, and said pair of lock switch mounting holes are aligned with the pair of faceplate mounting holes.

The following are optional, exemplary aspects of the invention: the main body portion can be formed of a rigid plastic; the main body portion can be mounted over the toggle switch faceplate in two different orientations, such that the first orientation locks the switch in the one of an off position and an on position, and the second orientation locks the switch in the other of an off position and an on position; the main body portion can be substantially flat; and the main body portion can include an offset portion such that a frame of the toggle switch abuts said main body portion.

According to another exemplary embodiment, the present invention can be embodied in a toggle switch locking faceplate for locking a toggle switch in one of an off position and an on position, comprising: a main body portion formed of a rigid material; a pair of switch lock mounting holes defined by the rigid material; and a switch position aperture defined by the rigid material. The main body is adapted to attach to a toggle switch having a pair of switch mounting holes, such that a first portion of the toggle switch that represents the one of an off position and an on position abuts said main body portion so as to lock the switch in the one of an on position and an off position, a second portion of the toggle switch that represents the other of an off position and an on position extends through said switch position aperture, and pair of said switch lock mounting holes are aligned with the switch mounting holes.

The following are optional, exemplary aspects of this embodiment of the present invention: the main body portion can be formed of a rigid plastic; the main body portion can be mounted to the toggle switch in at least two different orientations, such that the first mounting orientation locks the switch in the one of an off position and an on position, and the second orientation locks the switch in the other of an off position and an on position; the main body portion can be substantially flat; the main body portion can include an offset portion to allow a frame of the decor toggle switch to abut said main body portion.

### BRIEF DESCRIPTION OF THE DRAWINGS

The present invention is illustrated by way of example, and not in limitation, in the figures of the accompanying drawings, in which:

FIG. 1 illustrates an exemplary toggle switch and an exemplary faceplate.

FIG. 2 illustrates an exemplary faceplate attached to an exemplary toggle switch, and an exemplary switch lock according to an exemplary embodiment of the present invention.

FIG. 3 illustrates an exemplary attachment of an exemplary switch lock to an exemplary faceplate in combination with an exemplary switch.

FIG. 4 illustrates another exemplary embodiment of the present invention attached to an exemplary switch.

### DETAILED DESCRIPTION OF THE INVENTION

The invention will now be described in more detail by way of example with reference to the embodiments shown in the accompanying figures. It should be kept in mind that the following described embodiments are only presented by way of example and should not be construed as limiting the inventive concept to any particular physical configuration or order.

According to an exemplary embodiment of the present invention, a switch lock includes a main body portion formed of a rigid material, a switch position aperture, and at least two switch lock mounting holes. In one embodiment, the main body portion is adapted to mount over a faceplate such that it abuts a portion of a switch actuator, which physically locks the switch actuator from changing (moving) the present state of the switch, with the present state of the switch being represented by another portion of the switch actuator, which extends through the switch position aperture.

In another embodiment of the present invention, a switch lock is embodied in a switch locking faceplate, with the faceplate having a switch position aperture therein. The switch locking faceplate is adapted to mount over a switch such that it abuts a portion of a switch actuator, which physically locks the switch actuator from (moving) changing the present state of the switch, with the present state of the switch being represented by another portion of the switch actuator, which extends through the switch position aperture.

According to an exemplary aspect of the present invention, the main body portion is formed of a rigid material, which prevents a switch actuator from moving from one position to another. Any type of material or combination of materials can be utilized, such as, for example and not in limitation, a plastic or metal, and would ultimately be a design choice, as long as the material or combination does not prohibit the locking function of the present invention. The level of rigidity can vary based on cost and/or one or more other design choices, such as an assessment based on the width of the main body portion, for example and not in limitation. Notably, by including at least two mounting holes through which a lock is mounted to a switch or faceplate, the level of required rigidity can decrease, which can reduce the overall cost of production, as well as the increase of security in the locking function.

Notably, the switch lock of the present invention can be mounted in at least two orientations relative to a switch or faceplate. This allows either state of a switch to be locked in place via the switch lock mounting orientation. For example, the switch lock can be mounted in a first orientation or a second orientation 180° thereto.

According to yet another exemplary aspect of the present invention, the main body portion can be formed to be substantially flat. According to a further exemplary aspect, the main body portion can include an offset portion to accommodate a switch that has a frame that extends slightly outwardly from the switch.

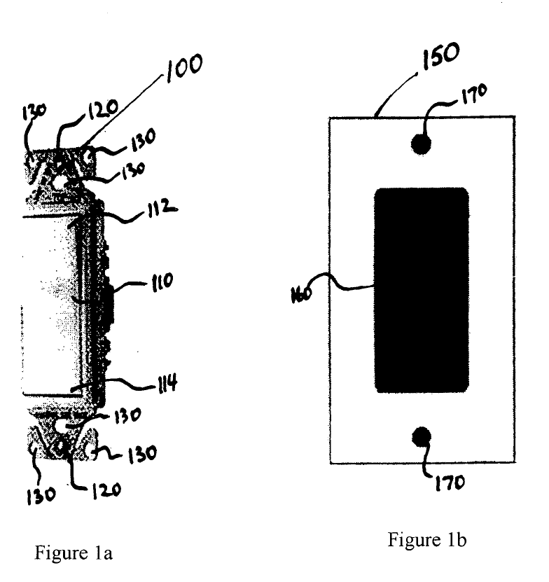

Figure la illustrates an exemplary decor-styled switch 100 having a paddle 110, switch mounting holes 120, and switch fixing holes 130. Paddle 110 provides a mechanical means for toggling switch 100 between on and off states. Each state is activated by pushing inwardly either the top 112 or bottom 114 of paddle 110, respectively, resulting in the other of the top or bottom being extended outwardly via a fulcrum action. Switch mounting holes 120 are provided to fixably accept screws or bolts (not shown) so as to secure a faceplate (illustrated by FIG. 1b below) thereto. Fixing holes 130 are provided to secure switch 100 to an electrical box (not shown) disposed within a wall, floor, ceiling, or other type of structure via screws or bolts (not shown). It should be noted, however, that switch 100 is merely one particular example of an electrical switch. Indeed, switches can be provided in plural sizes and shapes, and further, can be oriented in different ways relative to user operation. Yet, as will be apparent from this disclosure, the present invention can accommodate plural types of switches.

FIG. 1b illustrates an exemplary decor-styled faceplate 150 having a switch access aperture 160 and faceplate mounting holes 170. Switch access aperture 160 is complementarily-sized to allow paddle 110 to be accessible for mechanical operation when faceplate 150 is mounted to switch 100. Faceplate 150 is mounted to switch 100 via screws or bolts (not shown) that pass through faceplate mounting holes 170 and fix to switch mounting holes 120.

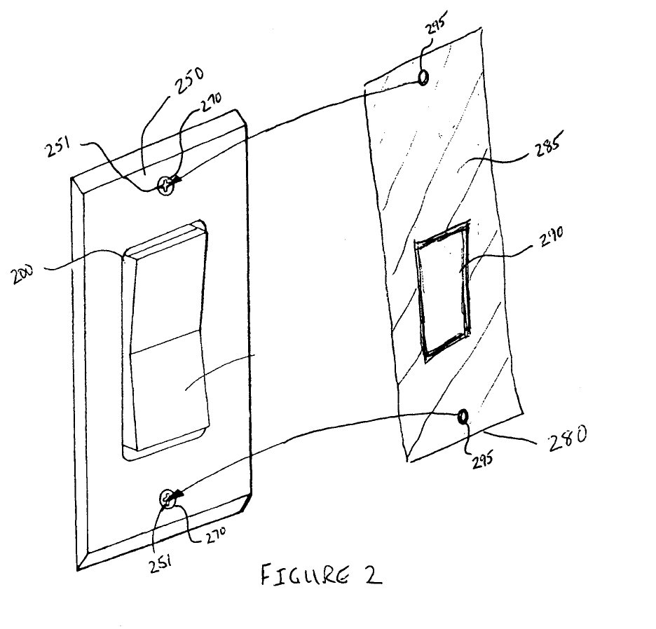

FIG. 2 illustrates an exemplary switch 200 having an exemplary faceplate 250 attached thereto via screws or bolts 251, and an exemplary switch lock 280 according to an exemplary embodiment of the present invention. Switch lock 280 includes a main body portion 285, a switch position aperture 290 and switch lock mounting holes 295. As illustrated in FIG. 2, switch position aperture 290 is complementarily-sized to allow one of the top 212 and the bottom 214 of paddle 210 to extend through switch position aperture 290. As also illustrated, switch lock mounting holes 295 are complementarily positioned to align with faceplate mounting holes 270, such that lock 280 can be mounted to faceplate 250. Accordingly, when lock 280 is attached over faceplate 250 the other of top 212 and bottom 214, which would be pressed inwardly, would generally abut main body portion 285, which would prevent the state associated therewith from being changed. In other words, this would prevent the abutting portion of paddle 210 from moving outwardly, and this prevention would lock switch 200 in the state associated with the non-abutting portion.

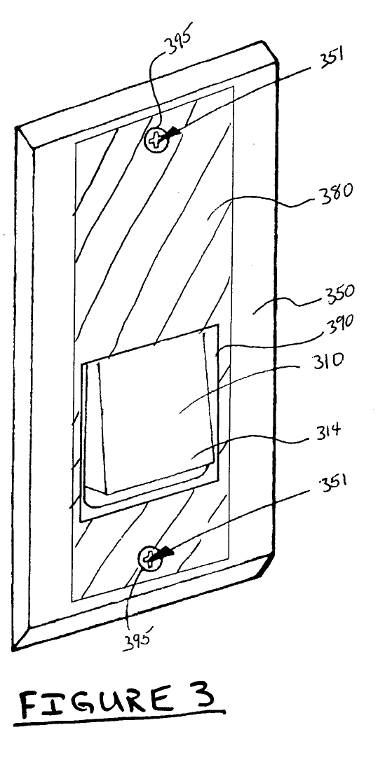

FIG. 3 illustrates an exemplary switch lock 380 attached to an exemplary faceplate 350, with the bottom 314 of a paddle 310 extending through a switch position aperture 390. As illustrated, switch lock mounting holes 395 align with faceplate mounting holes 370 (not shown), such that lock 380 is mounted to faceplate 350 via screws or bolts 351.

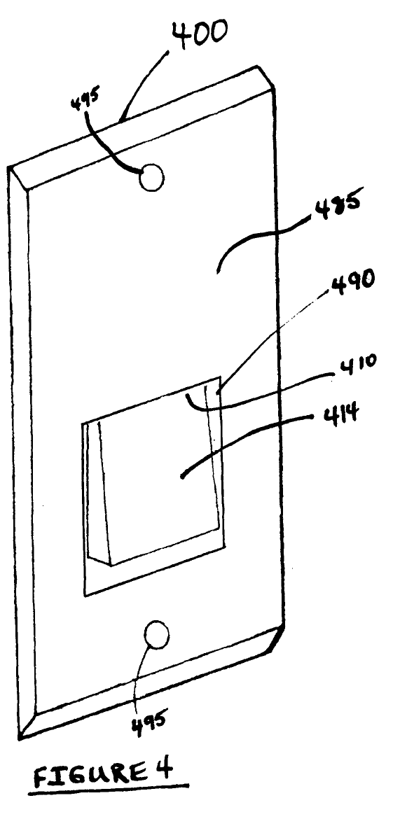

FIG. 4 illustrates another exemplary embodiment of the present invention, in which a switch lock is embodied in a switch locking faceplate 400, with the switch locking faceplate having a main body portion 485, a switch position aperture 490, and switch lock mounting holes 495. Switch locking faceplate 400 is adapted to mount over a switch such that it abuts a portion of a switch paddle 410, which physically locks the paddle from (moving) changing the present state of the switch, with the present state of the switch being represented by another portion 414 of paddle 410, which extends through switch position aperture 490.

In the foregoing specification, the invention has been described with reference to specific exemplary embodiments thereof. It will, however, be evident that various modifications and/or changes may be made thereto without departing from the broader spirit and scope of the invention. For example, the size of switch lock can vary. While the overall height must reach the existing mounting holes of a switch or faceplate, there is generally no maximum size limitation to height. Further, while the width requirements of a lock must be sufficient to prevent (in conjunction with the rigidity level of the material used) an abutting portion of an actuator switch from moving, there is generally no maximum size limitations to width. Further, the present invention is well suited for locking various types of switches, such as the decor and standard varieties, with the latter having the switch lock preventing an actuator from moving either upwardly or downwardly. Accordingly, the specification and drawings are to be regarded in an illustrative and enabling rather than a restrictive sense.

Therefore, I claim:

1. A toggle switch lock for locking a toggle switch in one of an off position and an on position, comprising:
a main body portion formed of a rigid material;
a pair of switch lock mounting holes defined by the material; and
a switch position aperture defined by the material;
wherein said main body portion is adapted to attach to a toggle switch faceplate having a pair of faceplate mounting holes, such that a first portion of the toggle switch that represents the one of an off position and an on position abuts said main body portion so as to lock the switch in the one of an on position and an off position, a second portion of the toggle switch that represents the other of an off position and an on position extends through said switch position aperture, and said pair of switch lock mounting holes are aligned with the pair of faceplate mounting holes.

2. The toggle switch lock of claim 1, wherein said main body portion is formed of a rigid plastic.

3. The toggle switch lock of claim 1, wherein said main body portion can be mounted over the toggle switch faceplate in at least two different orientations, such that the first orientation locks the switch in the one of an off position and an on position, and the second orientation locks the switch in the other of an off position and an on position.

4. The toggle switch lock of claim 1, wherein said main body portion is substantially flat.

5. The toggle switch lock of claim 1, wherein said main body portion includes an offset portion such that a frame of the toggle switch abuts said main body portion.

6. A toggle switch locking faceplate for locking a toggle switch in one of an off position and an on position, comprising:
a main body portion formed of a rigid material;
a pair of switch lock mounting holes defined by the rigid material; and
a switch position aperture defined by the rigid material;
wherein said main body portion is adapted to attach to a toggle switch having a pair of switch mounting holes, such that a first portion of the toggle switch that represents the one of an off position and an on position abuts said main body portion so as to lock the switch in the one of an on position and an off position, a second portion of the toggle switch that represents the other of an off position and an on position extends through said switch position aperture, and said pair of switch lock mounting holes are aligned with the switch mounting holes.

7. The toggle switch lock of claim 6, wherein said main body portion is formed of a rigid plastic.

8. The toggle switch lock of claim 6, wherein said main body portion can be mounted over the toggle switch faceplate in at least two different orientations, such that the first orientation locks the switch in the one of an off position and an on position, and the second orientation locks the switch in the other of an off position and an on position.

9. The toggle switch lock of claim 6, wherein said main body portion is substantially flat.

10. The toggle switch lock of claim 6, wherein said main body portion includes an offset portion such that a frame of the toggle switch abuts said main body portion.
